(19) United States
(12) Patent Application Publication
(10) Pub. No.: US 2024/0136669 A1
(43) Pub. Date: Apr. 25, 2024

(54) BATTERY MODULE BUSBAR AND METHOD OF MANUFACTURING THE SAME

(71) Applicant: HYUNDAI MOBIS CO., LTD., Seoul (KR)

(72) Inventor: Ju Hwan KIM, Yongin-si (KR)

(73) Assignee: HYUNDAI MOBIS CO., LTD., Seoul (KR)

(21) Appl. No.: 18/380,857

(22) Filed: Oct. 16, 2023

(30) Foreign Application Priority Data
Oct. 20, 2022 (KR) 10-2022-0136066

(51) Int. Cl. H01M 50/526; H01M 10/658; H01M 50/517; H01M 50/524

(52) U.S. Cl. CPC H01M 50/526; H01M 10/658; H01M 50/517; H01M 50/524; H01M 50/505

(57) ABSTRACT

The present disclosure relates to a battery module busbar and a method of manufacturing the same. A battery module busbar according to one embodiment of the present disclosure can include a body, a first terminal part provided on one end of the body and electrically connected to a battery module, a second terminal part provided on the other end of the body, electrically connected to a battery module, and bent from the body, and a melting part provided on one surface of the first terminal part and formed of a material which melts at a predetermined temperature or more.

### CROSS-REFERENCE TO RELATED APPLICATION

This application claims priority to and the benefit of Korean Patent Application No. 2022-0136066, filed on Oct. 21, 2022, the disclosure of which is incorporated herein by reference in its entirety.

### BACKGROUND

### 1. Field of the Invention

The present disclosure relates to a battery module busbar, and more specifically, to a battery module busbar for electrical connection between battery modules, and a method of manufacturing the same.

### 2. Discussion of Related Art

Unlike primary batteries which cannot be charged, secondary batteries can be charged and discharged, and are used in not only small and high-tech electronic devices such as cell phones, notebook computers, and computers but also power sources for energy storage systems (ESSs), electric vehicles, and hybrid vehicles.

The secondary batteries widely used in the ESSs, the electric vehicles, and the like may be classified into lithium-ion batteries, lithium-polymer batteries, nickel-cadmium batteries, nickel-hydrogen batteries, nickel-zinc batteries, and the like, and are repeatedly charged and discharged with an output voltage of approximately 25 V to 42 V per unit cell. Accordingly, when a higher output voltage and a higher power capacity are required, a plurality of battery cells are connected in series to form battery modules, or the battery modules are connected in series or parallel and are combined with additional other circuits to form battery packs.

However, compared to other batteries, the lithium-ion cells are vulnerable to fire. Typically, thermal runaway occurs when an internal temperature of a lithium-ion battery is 170° C. or more. Accordingly, even when a problem occurs in one battery, a fire quickly spreads to all batteries. To prevent this, there are a method of blocking power using sensors and the like and a method of providing fire extinguishing devices outside a battery, but it is difficult to apply the methods to electric vehicles due to the increases of weight, volume, and cost.

In the battery pack, a busbar, through which a current is quickly supplied to the battery modules and a high-voltage short circuit current flows to a fuse when thermal runaway occurs or an abnormal signal of the battery is detected to physically disconnect the battery modules, is provided.

The busbar includes a copper conductor and an insulator surrounding an outer portion of the busbar to prevent a short circuit. However, there have been problems that, when a fire occurs in the battery, a short circuit occurs due to burning of an insulating layer of the outer portion of the busbar, heat is applied to normal battery modules due to problems of heat transfer between the battery modules through copper and the like, and thus the thermal runaway spreads. In addition, when an abnormality in the battery occurs, a high-voltage short circuit current flows to each battery module through the busbar (physical disconnection using a fuse), and in this case, when the insulating layer of the busbar is destroyed by the fire, a short circuit may rather occur to facilitate the fire, or a driver's safety may be threatened.

### SUMMARY OF THE INVENTION

The present disclosure is directed to providing a battery module busbar of which an insulation function is stably maintained and a signal and a current are transmitted normally even when a fire occurs in a battery and which prevents the fire from spreading between battery modules, and a method of manufacturing the same.

Objectives to be solved by the present disclosure are not limited to the above-described objectives, and the other objectives which are not described above will be clearly understood by those skilled in the art from the following description.

According to an aspect of the present disclosure, there is provided a battery module busbar including a body, a first terminal part provided on one end of the body and electrically connected to a battery module, a second terminal part provided on the other end of the body, electrically connected to a battery module, and bent from the body, and a melting part provided on one surface of the first terminal part and formed of a material which melts at a predetermined temperature or more.

The second terminal part may be bent to be inclined upward from the body.

The melting part may be formed of a synthetic resin material which melts at 200 to 300° C.

The battery module busbar may further include a first flame-retardant plate provided to surround the body, a flame-retardant sheet attached to surround the first flame-retardant plate, and a second flame-retardant plate provided to surround the flame-retardant sheet.

At least one fixing clip for fixing the first flame-retardant plate during molding may be coupled to one side of the body.

A connecting part for connection with the first flame-retardant plate when the second flame-retardant plate is molded may be formed in the flame-retardant sheet.

The connecting part may have a hole or slit shape.

A first fastening hole and a second fastening hole for fastening with fastening bolts may be formed in the first terminal part and the second terminal part.

A third fastening hole corresponding to the first fastening hole may be formed in the melting part.

According to another aspect of the present disclosure, there is provided a method of manufacturing a battery module busbar including a first terminal part provided in one end of a body and electrically connected to a battery module and a second terminal part provided on the other end of the body and electrically connected to a battery module, the method including bending the second terminal part from the body and forming a melting part formed of a material, which melts at a predetermined temperature or more, on one surface of the first terminal part.

The method may further include, after the bending of the second terminal part, molding a first flame-retardant plate to surround the body, attaching a flame-retardant sheet to surround the first flame-retardant plate, and molding a second flame-retardant plate to surround the flame-retardant sheet.

The method may further include attaching at least one fixing clip, which is for fixing the first flame-retardant plate during molding, to one side of the body.

The method may further include forming a connecting part, which is for connection with the flame-retardant sheet, in the first flame-retardant plate before the second flame-retardant plate is molded.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIGS. 1 to 6 are views sequentially illustrating a manufacturing process of a battery module busbar according to one embodiment of the present disclosure;

FIG. 7 is a view illustrating a side surface the battery module busbar according to one embodiment of the present disclosure;

FIG. 8 is a view illustrating the battery module busbar mounted on battery modules according to one embodiment of the present disclosure; and

FIG. 9 is a view illustrating melting of a melting part of the battery module busbar according to one embodiment of the present disclosure.

### DETAILED DESCRIPTION OF EXEMPLARY EMBODIMENTS

Since the present disclosure allows for various changes and numerous embodiments, specific embodiments will be illustrated in the accompanying drawings and described in the detailed description. However, this is not intended to limit the present disclosure to the specific embodiments, and it is to be appreciated that all changes, equivalents, and substitutes falling within the spirit and technical scope of the present disclosure are encompassed in the present disclosure. In the description of the embodiments, certain detailed descriptions of the related art are omitted when it is deemed that they may unnecessarily obscure the gist of the inventive concept.

While terms such as “first” and “second” may be used to describe various components, such components are not limited by the above terms. The above terms are used only to distinguish one component from another.

The terminology used herein is for the purpose of describing particular embodiments only and is not intended to limit the present disclosure. The singular forms are intended to include the plural forms, unless the context clearly indicates otherwise. In the present specification, it should be understood that the terms “comprise,” “comprising,” “include,” and/or “including,” when used herein, specify the presence of stated features, numbers, steps, operations, elements, components, and/or combinations thereof but do not preclude the presence or addition of one or more other features, numbers, steps, operations, elements, components, and/or combinations thereof.

In addition, throughout the specification, when “connected,” not only this means that two or more components are directly connected, but this also means that two or more components are indirectly connected through other components or are physically connected as well as electrically connected, or are one thing even referred to as different names according to positions or functions thereof.

Hereinafter, when a battery module busbar and a method of manufacturing the same according to the present disclosure will be described in detail with reference to the accompanying drawings, components which are the same or correspond to each other will be denoted by the same reference numerals, and redundant description will be omitted.

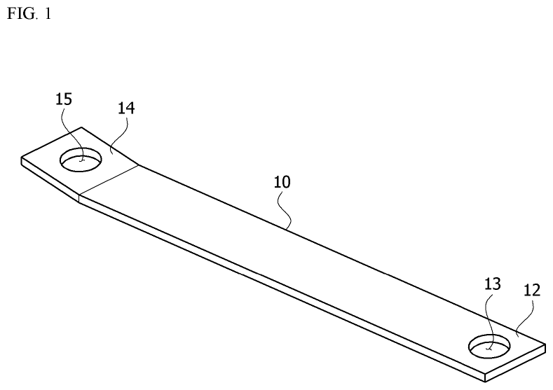

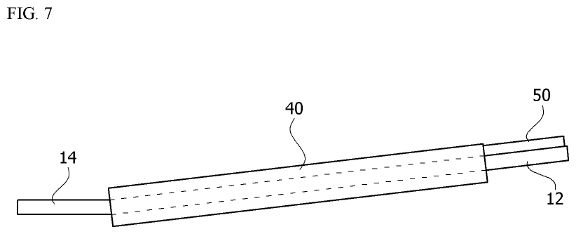

FIGS. 1 to 6 are views sequentially illustrating a manufacturing process of a battery module busbar according to one embodiment of the present disclosure, and FIG. 7 is a view illustrating a side surface the battery module busbar according to one embodiment of the present disclosure.

According to the illustrated drawings, a battery module busbar according to one embodiment of the present disclosure may include a body 10, a first terminal part 12 provided on one end of the body 10 and electrically connected to a battery module 60, a second terminal part 14 provided on the other end of the body 10, electrically connected to a battery module 60, and bent from the body 10, and a melting part 50 provided on one surface of the first terminal part 12 and formed of a material which melts at a predetermined temperature or more.

The body 10 has a rectangular metal plate shape, and the first terminal part 12 and the second terminal part 14 are formed on both ends. The first terminal part 12 and the second terminal part 14 are actually electrically connected to the battery modules 60. Although not specifically illustrated in the drawings, the body 10 may be a linear metal plate as illustrated in the drawings or a metal plate having a partially curved shape to be connected to one end portions of the battery modules 60 positioned far away.

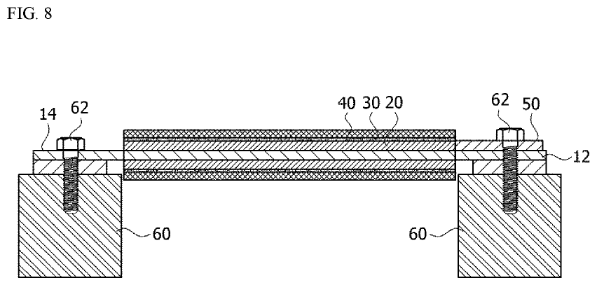

A first fastening hole 13 and a second fastening hole 15 for fastening with fastening bolts 62 are formed in the first terminal part 12 and the second terminal part 14. The second terminal part 14 may be bent to be inclined upward from the body 10. The reason why the second terminal part 14 is bent as described above is to electrically disconnect the second terminal part 14 from the battery module 60 though elasticity of the body 10 as the melting part 50 melts and disappears when a fire occurs in the battery module 60 and thermal runaway occurs. More specifically, when the second terminal part 14 is coupled using the fastening bolt 62 (see FIG. 8), since the second terminal part 14 is pressed and fastened, the second terminal part maintains a horizontal state with respect to the body 10. In this case, when the melting part 50 melts due to the spread of the fire, the body 10 returns to its original bent state due to the elasticity of the body 10, and thus the body 10 is electrically disconnected from the battery module 60.

In the drawings, it is illustrated that the second terminal part 14 is bent to be inclined with respect to the body 10, but the present disclosure is not limited thereto, and as long as the body 10 may have an elastic force with respect to the second terminal part 14, any shape may be applied.

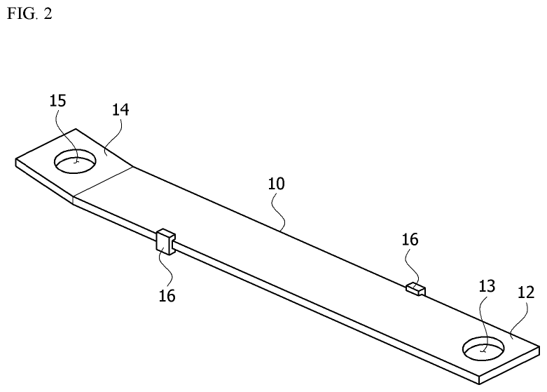

As described above, in order to manufacture the battery module busbar, the second terminal part 14 is bent from the body 10 as illustrated in FIG. 1. Then, as illustrated in FIG. 2, one or more fixing clips 16 for fixing a first flame-retardant plate 20 during molding are attached to one side of the body 10.

The fixing clip 16 is provided to fix the first flame-retardant plate 20 to a mold when the first flame-retardant plate 20 is molded, and when there is no fixing clip 16, since a portion corresponding to the fixing clip 16 remains as an empty space after the first flame-retardant plate 20 is molded, the fixing clip 16 is attached to fill the empty space before the first flame-retardant plate 20 is molded.

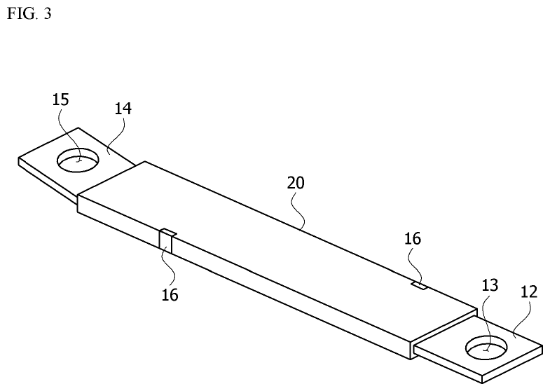

Referring to FIG. 3, the first flame-retardant plate 20 may be molded to surround the body 10. The first flame-retardant plate 20 is formed of a flame-retardant material to block the transfer of a flame and heat and also performs an insulation function.

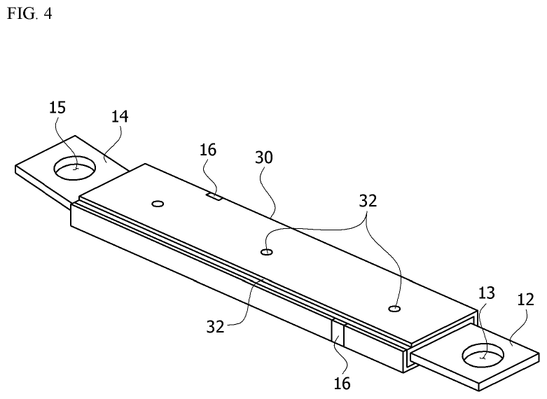

Referring to FIG. 4, a flame-retardant sheet 30 is attached to surround the first flame-retardant plate 20. The flame-retardant sheet 30 is also formed of a material capable of blocking the transfer of a flame and heat, and for example, a mica sheet or aerogel sheet may be used as the flame-retardant sheet 30. The flame-retardant sheet 30 may be attached to an outer surface of the first flame-retardant plate 20 through an insert molding process. Meanwhile, a connecting part 32 for connection with the first flame-retardant plate 20 may be formed in the flame-retardant sheet 30 before the second flame-retardant plate 40 is molded. The connecting part 32 may have a hole or slit shape as illustrated in the drawings.

In the present embodiment, the reason why the connecting part 32 is formed is to fill the connecting part 32 with the second flame-retardant plate 40 so that the second flame-retardant plate 40 is connected to the first flame-retardant plate 20 when the second flame-retardant plate 40 is molded. Accordingly, a coupling force between the first flame-retardant plate 20 and the second flame-retardant plate 40 can increase.

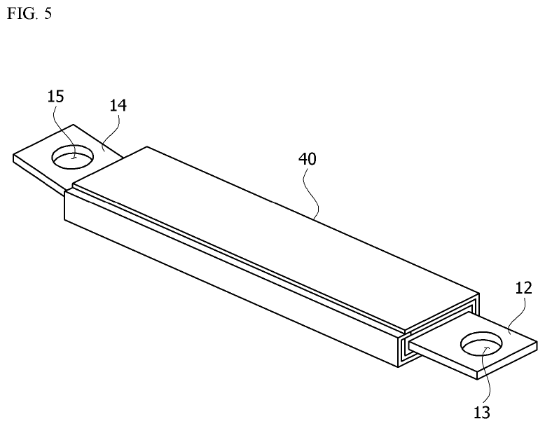

Referring to FIG. 5, the second flame-retardant plate 40 may be molded to surround the flame-retardant sheet 30. The second flame-retardant plate 40 may be formed of the same material as the first flame-retardant plate 20. Before the second flame-retardant plate 40 is molded, the fixing clip 16 may be attached to one side of the body 10. As described above, when the first flame-retardant plate 20, the flame-retardant sheet 30, and the second flame-retardant plate 40 are provided on an outer surface of the body 10 as three layers, as the transfer of a flame and heat is blocked when a fire occurs in the battery module 60, a signal and a current can be transmitted through the busbar normally. For example, each of the first flame-retardant plate 20 and the second flame-retardant plate 40 may have a thickness of 0.5 to 2.0 mm.

However, in the above description, it has been described that the first flame-retardant plate 20, the flame-retardant sheet 30, and the second flame-retardant plate 40 are provided as the three layers, but the present disclosure is not limited thereto, and various combinations, such as having only the flame-retardant sheet 30 and the second flame-retardant plate 40, may be provided.

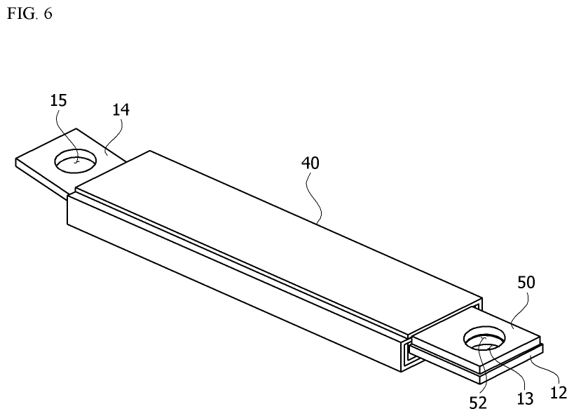

Referring to FIG. 6, the melting part 50 formed of the material which melts at the predetermined temperature or more may be formed on one surface, that is, an upper surface of the first terminal part 12. The melting part 50 may be formed of a synthetic resin material which melts at 200 to 300° C. and may have a washer shape as illustrated in the drawing. A third fastening hole 52 corresponding to the first fastening hole 13 may be formed in the melting part 50 and fastened to the battery module 60 using the fastening bolt 62. The melting part 50 may be formed of a plastic based on polypropylene (PP), modified polyphenylene oxide (MPPO), polyethylene (PE), or polyamide 6 (PA6) and may have a thickness of, for example, 0.5 to 5.0 mm.

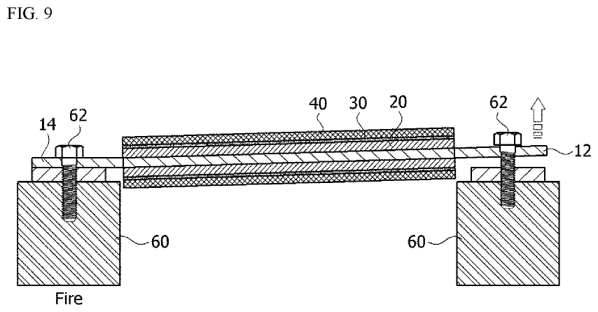

FIG. 8 is a view illustrating the battery module busbar mounted on the battery modules according to one embodiment of the present disclosure, and FIG. 9 is a view illustrating melting of the melting part of the battery module busbar according to one embodiment of the present disclosure.

Referring to FIG. 8, the busbar may be mounted for electrical connection between two adjacent battery modules 60. The first terminal part 12 and the second terminal part 14 of the busbar are fastened to the battery modules 60 using the fastening bolts 62 to perform electrical connection as illustrated in the drawings.

In this case, the second terminal part 14 is connected to the fastening bolt 62 first, and then the first terminal part 12 is fastened using the fastening bolt 62 and pressed against the battery module 60. That is, the body 10 bent upward from the second terminal part 14 is fastened and pressed, and the second terminal part 14 provides an elastic force upward.

Referring to FIG. 9, when a fire occurs in the battery module 60 disposed at a left side, a flame and heat may be transferred to the body 10 through the second terminal part 14. In this case, the first flame-retardant plate 20, the flame-retardant sheet 30, and the second flame-retardant plate 40 which are provided on the body 10 have a triple structure to block the flame and heat from spreading to the battery module 60 disposed on a right side.

However, when the flame and heat is transferred to the battery module disposed at the right side, because it is difficult to block the spread of the flame and heat even with the busbar structure, the melting part 50 melts. That is, when a temperature higher than a melting point of the melting part 50 is transferred, the melting part 50 melts, and then, since a supporting part between the fastening bolt 62 and the first terminal part 12 disappears, the first terminal part 12 moves upward as illustrated in the drawing. In this case, the first terminal part 12 may be moved by an elastic force of the body 10.

As a result, when the first terminal part 12 is moved upward, since the first terminal part 12 is not only electrically disconnected from the battery module 60 but also physically disconnected from the battery module 60, a flame and heat being transferred to the battery module 60 can be blocked.

According to one embodiment of the present disclosure, since an insulation function is stably maintained even when a fire occurs in a battery, a signal and a current can be transmitted normally, and spread of the fire between battery modules can be prevented.

While the present disclosure has been described above with reference to exemplary embodiments, it may be understood by those skilled in the art that various modifications and changes of the present disclosure may be formed within a range not departing from the spirit and scope of the present disclosure defined by the appended claims.

What is claimed is:

1. A battery module busbar comprising:
a body;
a first terminal part provided on one end of the body and connected to a battery module;
a second terminal part provided on the other end of the body, connected to a battery module, and bent from the body; and
a melting part provided on one surface of the first terminal part and including a material which melts at a predetermined temperature or higher.

2. The battery module busbar of claim 1, wherein the second terminal part is bent to be inclined upward from the body.

3. The battery module busbar of claim 1, wherein the melting part includes a synthetic resin material which melts at 200 to 300° C.

4. The battery module busbar of claim 1, further comprising:
a first flame-retardant plate provided to surround the body;
a flame-retardant sheet attached to surround the first flame-retardant plate; and
a second flame-retardant plate provided to surround the flame-retardant sheet.

5. The battery module busbar of claim 4, wherein at least one fixing clip for fixing the first flame-retardant plate and embedded in the second flame-retardant plate.

6. The battery module busbar of claim 4, wherein the flame-retardant sheet includes a connecting part for connection the first flame-retardant plate with the second flame-retardant plate.

7. The battery module busbar of claim 6, wherein the connecting part has a hole or slit shape.

8. The battery module busbar of claim 1, wherein the first terminal part and the second terminal part have a first fastening hole and a second fastening hole for fastening with fastening bolts.

9. The battery module busbar of claim 8, wherein the melting part has a third fastening hole corresponding to the first fastening hole.

10. The battery module busbar of claim 1, wherein the predetermined temperature is 200° C.

11. A method of manufacturing a battery module busbar including a first terminal part provided in one end of a body and connected to a battery module and a second terminal part provided on the other end of the body and connected to a battery module, the method comprising:
bending the second terminal part from the body; and
forming a melting part formed of a material, which melts at a predetermined temperature or higher, on one surface of the first terminal part.

12. The method of claim 11, further comprising, after the bending of the second terminal part:
molding a first flame-retardant plate to surround the body;
attaching a flame-retardant sheet to surround the first flame-retardant plate; and
molding a second flame-retardant plate to surround the flame-retardant sheet.

13. The method of claim 12, further comprising attaching at least one fixing clip, which is for fixing the first flame-retardant plate during molding, to one side of the body.

14. The method of claim 12, further comprising forming a connecting part, which is for connection with the flame-retardant sheet, in the first flame-retardant plate before the second flame-retardant plate is molded.

15. The method of claim 11, wherein the predetermined temperature is 200° C.
